(19) United States
(12) Patent Application Publication
(10) Pub. No.: US 2024/0334328 A1
(43) Pub. Date: Oct. 3, 2024

(54) RADIO FREQUENCY COMMUNICATIONS

(71) Applicant: Nordic Semiconductor ASA, Trondheim (NO)

(72) Inventors: Hubert MIS, Krakow (PL); Lukasz Jan DUDA, Krakow (PL)

(73) Assignee: Nordic Semiconductor ASA, Trondheim (NO)

(21) Appl. No.: 18/615,961

(22) Filed: Mar. 25, 2024

(30) Foreign Application Priority Data
Mar. 31, 2023 (GB) 2304860.6

(51) Int. Cl. H04W 52/02

(52) U.S. Cl. CPC H04W 52/0229

(57) ABSTRACT

A radio frequency receiver arranged to monitor for wake-up frames in a plurality of sample windows is provided. The wake-up frames are transmitted by a radio frequency transmitter in a sequence according to one or more sequence parameters including a wake-up interval between each wake-up frame of the sequence, and each sample window has a sample duration that is less than the wake-up interval. The sample windows occur in a pattern based on at least one of the one or more sequence parameters, such that the radio frequency receiver is arranged to detect at least one of the sequence of wake-up frames.

### CROSS REFERENCE TO RELATED APPLICATION

This application claims priority from Great Britain Application No. 2304860.6, filed Mar. 31, 2023, which application is incorporated herein by reference in its entirety.

### BACKGROUND OF THE INVENTION

The present invention relates to radio frequency (RF) communications.

Radio frequency communication devices communicate using radio frequency signals in which data is encoded. Many RF devices are battery-powered and so it is desirable to limit power use when possible. The sending and receiving of radio signals can be relatively power intensive.

Many RF devices only need to communicate intermittently. For instance, devices operating as part of a low rate wireless network may encounter extended periods in which there is no communication between participating devices. In these periods, it is advantageous to minimise transmission and reception operations to save power whilst maintaining the ability to resume communications without excessive latency when needed.

The IEEE 802.15.4 standard outlines an approach to low-data-rate wireless connectivity which includes a coordinated sampled listening (CSL) mode. CSL mode operation for unsynchronised coordinator and endpoint devices is illustrated in FIG. 1. In the CSL mode, the endpoint device listens for transmissions from the coordinator device in periodic sample windows 102 and switches its radio off between these to save power. The sample windows 102 have a period macCslPeriod and a duration sampleDuration.

When the coordinator device wants to initiate communication with the endpoint device, it transmits a wake-up sequence 104 of periodic wake-up frames 106. The wake-up sequence lasts for up to macCslMaxPeriod, and there is a wake-up interval macCslInterval between each frame. The endpoint device can use information contained in the received wake-up frame 106 to begin full communications with the coordinator device.

The maximum length of the wake-up sequence (macCsIMaxPeriod) is set by the maximum transmission latency allowed in the communication system. The sample period macCslPeriod is less than the maximum length of the wake-up sequence (macCslMaxPeriod), and the sample windows 102 are at least as long as the wake-up interval macCslInterval. This ensures that at least one wake-up frame 106 of any given wake-up sequence 104 will be received by the endpoint device (i.e. to ensure that the maximum allowed latency is met).

The use of the CSL mode can reduce power use by the coordinator and endpoint in periods when active communication is not required. However, further power savings may be desirable.

### SUMMARY OF THE INVENTION

According to a first aspect of the present invention there is provided a radio frequency receiver arranged to monitor for wake-up frames in a plurality of sample windows;
wherein the wake-up frames are transmitted by a radio frequency transmitter in a sequence according to one or more sequence parameters including a wake-up interval between each wake-up frame of the sequence, and each sample window has a sample duration that is less than the wake-up interval; and
wherein the sample windows occur in a pattern based on at least one of the one or more sequence parameters, such that the radio frequency receiver is arranged to detect at least one of the sequence of wake-up frames.

According to a second aspect of the present invention there is provided a method of operating a radio frequency receiver comprising monitoring for wake-up frames in a plurality of sample windows;
wherein the wake-up frames are transmitted by a radio frequency transmitter in a sequence according to one or more sequence parameters including a wake-up interval between each wake-up frame of the sequence, and each sample window has a sample duration that is less than the wake-up interval; and
wherein the sample windows occur in a pattern based on at least one of the one or more sequence parameters, such that the radio frequency receiver detects at least one of the sequence of wake-up frames.

According to a third aspect of the present invention there is provided a radio frequency communication system comprising:
a radio frequency transmitter arranged to transmit a sequence of wake-up frames according to one or more sequence parameters including a wake-up interval between each wake-up frame of the sequence;
a radio frequency receiver according to the first aspect of the present invention, arranged to monitor for the wake-up frames in a plurality of sample windows.

According to a fourth aspect of the present invention there is provided a method of operating a radio frequency communication system comprising a radio frequency transmitter and a radio frequency receiver, the method comprising:
the radio frequency transmitter transmitting a sequence of wake-up frames according to one or more sequence parameters including a wake-up interval between each wake-up frame of the sequence;
the radio frequency receiver monitoring for wake-up frames in a plurality of sample windows, each sample window having a duration that is less than the wake-up interval;
wherein the monitoring windows occur in a pattern based on at least one of the one or more sequence parameters, such that the radio frequency receiver detects at least one of the sequence of wake-up frames.

Thus, it will be recognised by those skilled in the art that, energy use of the radio frequency receiver may be reduced compared to conventional approaches. By monitoring for wake-up frames in sample windows that are shorter than the wake-up interval (and could thus fall between wake-up frames of the sequence), a sampling duty cycle of the radio frequency receiver may be reduced. However, because the sample windows are in a pattern such that the radio frequency receiver will detect at least one of the sequence of wake-up frames, communication between the transmitter and receiver can nevertheless be established or resumed within an acceptable latency.

In other words, instead of using periodic sample windows that are long enough to guarantee reception of a wake-up frame of a coincident wake-up sequence, the radio frequency receiver monitors for wake-up frames in shorter windows that are not individually guaranteed to coincide with a wake-up frame if present but in a pattern that ensures at least one wake-up frame in the sequence will be detected.

The radio frequency receiver may be arranged to operate in an active communication mode for exchanging data payloads and/or signalling information with the radio frequency transmitter. In the active communication mode the receiver may synchronise with the radio frequency transmitter and exchange data payloads and/or signalling information with the radio frequency transmitter via a radio frequency channel. The radio frequency communication system may be considered as a whole to be in an active communication mode when the radio frequency transmitter and receiver are synchronised and exchanging data payloads and/or signalling information. The radio frequency transmitter and receiver may comprise radio frequency transceivers both operable to transmit and receive in the active communication mode.

The radio frequency receiver may be arranged to operate in an idle mode (i.e. when active communication is not needed). In the idle mode the radio frequency receiver is arranged to monitor for the wake-up frames in the plurality of sample windows. The radio frequency transmitter and receiver may not maintain synchronisation in the idle mode (i.e. the transmitter and receiver may be unsynchronised in the idle mode). The radio frequency transmitter may be arranged to transmit the sequence of wake-up frames to initiate a transition from the idle mode into the active communication mode.

In some scenarios, the radio frequency receiver may be monitoring for wake-up frames using the sample windows for a long time before the radio frequency transmitter transmits a sequence of wake-up frames (i.e. because no communication between the transmitter and receiver is required and the radio frequency communication system can remain in the idle mode). It will be recognised that minimising a sample duration in such situations can substantially reduce energy use.

The radio frequency receiver may be arranged to enter a lower-power mode between the sample windows (e.g. in which one or more components or circuit portions are powered-off). For instance, the radio frequency receiver may be powered off between the sample windows.

One or more of the wake-up frames may comprise information relating to communications within the radio frequency communication system. For instance, a wake-up frame may comprise a target address, i.e. identifying a receiver at which the wake-up sequence is targeted (i.e. the device that the radio frequency transmitter wishes to wake). Additionally or alternatively, a wake-up frame may comprise a rendezvous time, i.e. indicating a time at which active communication with the radio frequency transmitter is to resume (e.g. a time at which a payload frame will be transmitted). A wake-up frame may include information relating to the sequence of wake-up frames, e.g. identifying the wake-up interval and/or a number of wake-up frames in the sequence. A wake-up frame may comprise a media access control (MAC) frame. The wake-up frames of the wake up sequence may be substantially or entirely identical.

In a set of embodiments, detecting a wake-up frame comprises receiving the entire wake-up frame. Detecting a wake-up frame may comprise retrieving information comprised by said wake-up frame (e.g. decoding data in one or more portions of the wake-up frame). The radio frequency receiver may be arranged to perform one or more further actions depending on information retrieved from the wake-up frame.

For instance, the radio frequency receiver may be arranged to retrieve a target address from a detected wake-up frame. The radio frequency receiver may be arranged to disregard the wake-up frame if the target address does not correspond to an address of the radio frequency receiver (i.e. if the wake-up frame is not targeted at the radio frequency receiver). Conversely, the radio frequency receiver may be arranged to resume active communication with the radio frequency transmitter if the target address does correspond to an address of the radio frequency receiver.

The radio frequency receiver may be arranged to initiate or resume active communication with the radio frequency transmitter in response to detecting a wake-up frame. For instance, the radio frequency receiver may be arranged to initiate or resume active communication at a rendezvous time retrieved from the wake-up frame. Initiating or resuming active communication may comprise the radio frequency receiver transmitting a data request frame to the radio frequency transmitter or receiving a data payload frame from the radio frequency transmitter.

Because the sample windows are relatively short, it may not always be possible to receive a whole wake-up frame or to retrieve information from a detected wake-up frame in a sample window. In some embodiments, detecting a wake-up frame includes detecting a presence of the wake-up frame (without necessarily retrieving any information therefrom). For instance, a sample window may coincide with only part of a wake-up frame (e.g. the start or end of a wake-up frame). In some embodiments, the sample duration may be less than a wake-up frame duration. In a set of embodiments, the sample duration is less than 10 ms, less than 1 ms, less than 500 μs or less than 200 μs.

The use of shorter sample windows that may only detect part of a wake-up frame (e.g. only the presence of said wake-up frame) can bring significant power savings. Detection of the mere presence of a wake-up frame may also still be useful for establishing active communication between the transmitter and receiver, because it can provide the radio frequency receiver with information about the timing of the sequence of wake-up frames. This information may even be sufficient for resuming full communications. However, even if this is not the case, the timing information can be used to adjust the pattern of sample windows to ensure that a subsequent wake-up frame is more fully detected (e.g. ruffianly to enable the retrieval of communication information therefrom).

In a set of embodiments, the radio frequency receiver is arranged to adjust the pattern of one or more subsequent sample windows in response to detecting a wake-up frame (e.g. part of a wake-up frame) in a sample window. For instance, the radio frequency receiver may determine the approximate timing of a subsequent (e.g. next) wake-up frame based on the partial detection (e.g. using knowledge of the wake-up interval) and adjust the pattern such that a subsequent (e.g. next) sample window coincides with the subsequent wake-up frame. In other words, the radio frequency receiver may be arranged to refine the pattern of sample windows based on a partially detected wake-up frame to facilitate full reception of a subsequent wake-up frame (e.g. enabling information contained therein to be retrieved).

In a set of embodiments, the pattern of sample windows is such that the radio frequency receiver is arranged to detect a penultimate or earlier wake-up frame of the sequence. This means that even if a wake-up frame is only partially detected, there is always at least one further wake-up frame that can subsequently be fully detected (e.g. by adjusting the pattern of one or more subsequent sample windows).

Additionally or alternatively, if the radio frequency receiver detects the start of a wake-up frame in a sample window, it may extend said sample window to receive the whole wake-up frame (e.g. and retrieve information comprised therein).

In addition to the wake-up interval, the sequence of wake-up frames may accord to one or more other sequence parameters (on which the pattern of sample windows may be based). For instance, a sequence parameter may be a wake-up frame duration of a wake-up frame. The wake-up frames may all have the same duration. Each wake-up frame may comprise one or more repetitions of a wake-up frame unit (e.g. each unit corresponding to a conventional wake-up frame). It will be appreciated that a wake-up frame period may equal the wake-up interval plus the wake-up frame duration.

The sequence of wake-up frames may have an overall sequence length. The radio frequency communication system may have a maximum communication latency (i.e. a time it takes to resume active communication from the idle mode). The overall sequence length may correspond to the maximum communication latency (e.g. being equal to or less than the maximum latency). Because the pattern of sample windows is such that at least one wake-up frame of the sequence will be detected, this may ensure that communication can be established between the first and radio frequency receiver within the maximum communication latency.

Needing to establish and potentially refine the pattern of sample windows based on parameter(s) of the wake-up sequence may require additional processing resources and/or complicate idle mode operation. However, the inventors have recognised that this added complexity may be acceptable in many situations in return for potentially significant power savings in the idle mode.

In a set of embodiments, the sample windows repeat with a regular frequency (i.e. the sample windows are periodic with a sample period). The sample period may be less than a wake-up frame duration. The sample period may be longer than the wake-up interval. In a set of embodiments, a sample period is longer than a wake-up frame period (i.e. the wake-up interval plus a wake-up frame duration). It will be appreciated that when periodic sample windows are used, the sample period should be equal to a non-integer multiple or division of the wake-up frame period, to avoid a situation in which a sample never coincides with a wake-up frame. In some embodiments, a more complex pattern of sample windows may be used (e.g. with variable spacing between sample windows).

In a set of embodiments, the sample period is equal to the wake-up frame period plus or minus an offset. It will be recognised that the offset can be selected appropriately to ensure that to ensure that even in a worst case random phase offset between the sample windows and wake-up frames, a sample window will coincide with a wake-up frame before the end of the sequence. In some embodiments, the sample period is equal to an integer multiple of the wake-up frame period plus or minus an offset.

The offset may be based on the sample duration. The offset may be based on the wake-up frame duration. In a set of embodiments the sample duration is less than the wake-up frame duration and the offset is a difference between the sample and wake-up frame durations.

In a set of embodiments, the pattern of the sample windows comprises one or more groups of sample windows. Each group may comprise periodic sample windows (i.e. with a sample period). The pattern may comprise a plurality of periodic groups (i.e. with a group period).

The interval between groups of sample windows may be much longer than the interval between individual sample windows of the groups. In other words, the pattern of sample windows may comprise intermittent groups of periodic sample windows. The group period may be based on an overall sequence length of the wake-up sequence (e.g. to be equal to or less than the overall sequence length). This may ensure that at least one group coincides with a wake-up sequence.

In embodiments featuring groups of sample windows, the sample duration may be shorter than the wake-up frame duration and is preferably significantly shorter than the wake-up frame duration (e.g. the sample duration may be less than half or less than quarter of the wake-up frame duration). In groups comprising periodic sample windows, the sample period may be less than the wake-up frame duration (e.g. equal to a difference between the wake-up frame duration and the sample duration).

Each group of sample windows may have a group duration that is longer than the wake-up interval (e.g. longer than a wake-up frame period). This may ensure that at least one of the sample windows in a group coincides with a wake-up frame of a coincident wake-up sequence. In a set of embodiments, the group duration is equal to or longer than the wake-up frame period plus one or two times the sample duration. This may ensure that at least one of the sample windows in a group coincides with a penultimate or earlier wake-up frame of a coincident wake-up sequence.

As mentioned above, the radio frequency transmitter and receiver may be radio frequency transceivers both operable to transmit and receive radio frequency signals. The radio frequency transmitter may comprise a coordinator device of a radio frequency network. The radio frequency receiver may comprise an endpoint device of a radio frequency network. For instance, the radio frequency communication system may comprise a low-rate wireless network, such as a network according to IEEE standard 802.15.4.

In a set of embodiments, the radio frequency receiver is battery powered. The radio frequency receiver may have a total battery capacity of 50 Wh or less, 25 Wh or less, 10 Wh or less or 5 Wh or less.

The invention extends to computer software that, when executed by a radio frequency receiver, causes said radio frequency receiver to perform the method according to the second aspect disclosed herein. The radio frequency receiver may comprise a memory storing said software. The radio frequency receiver may comprise a processor arranged to execute said software.

Similarly, the invention extends to computer software that, when executed by a radio frequency receiver and a radio frequency transmitter of a radio frequency communication system, causes said radio frequency communication system to perform the method according to the fourth aspect disclosed herein. The radio frequency receiver and radio frequency transmitter may comprise memories storing at least part of said software. The radio frequency receiver and radio frequency transmitter may comprise processors arranged to execute at least part of said software.

Features of any aspect or embodiment described herein may, wherever appropriate, be applied to any other aspect or embodiment described herein. Where reference is made to different embodiments, it should be understood that these are not necessarily distinct but may overlap.

### BRIEF DESCRIPTION OF THE DRAWINGS

One or more non-limiting examples will now be described, by way of example only, and with reference to the accompanying figures in which:

FIG. 1 is a timing diagram illustrating behaviour of a radio frequency communication system known in the prior art;

FIG. 2 is a schematic diagram of a radio frequency communication system according to embodiments of the invention;

FIG. 3 is a timing diagram illustrating behaviour of the radio frequency communication system according to an embodiment of the invention;

FIG. 4 is a timing diagram offering a more detailed view of the behaviour illustrated in FIG. 3;

FIG. 5 is a timing diagram illustrating behaviour of the radio frequency communication system according to another embodiment of the invention;

FIG. 6 is a timing diagram illustrating behaviour of the radio frequency communication system according to another embodiment of the invention; and

FIG. 7 is a timing diagram illustrating behaviour of the radio frequency communication system according to another embodiment of the invention.

### DETAILED DESCRIPTION

A radio frequency communication system 200, shown in FIG. 2, comprises a first radio frequency device 202 and a second radio frequency device 204. The first and second radio frequency devices 202, 204 form a low-rate wireless personal area network according to IEEE 802.15.4 standard. The first radio frequency device 202 operates as a coordinator of the network, and the second radio frequency device 204 operates as an endpoint.

The first radio frequency device 202 comprises a memory 206, a processor 208, a radio transceiver 210 and a battery 212. The first radio frequency device 202 is powered by the battery 212. The memory 206 stores software that is executed by the processor 208 to cause the radio transceiver 210 to prepare and transmit data packets to the second radio frequency device 204 and to receive and process data packets from the second radio frequency device 204.

Similarly, the second radio frequency device 204 comprises a memory 214, a processor 216, a radio transceiver 218 and a battery 220. The second radio frequency device 202 is powered by the battery 220. The memory 214 stores software that is executed by the processor 216 to cause the second radio transceiver device 204 to receive and process data packets from the first radio transceiver device 202 and to prepare and transmit data packets to the first radio transceiver device 202.

The radio frequency communication system 200 is operable in an active communication mode, in which the first and second radio frequency devices 202, 204 communicate data in a radio frequency channel according to protocols set out in the IEEE 802.15.4 standard. However, there are long periods of time in which active communication between the devices 202, 204 is not necessary. In such time periods the radio frequency communication system 200 operates in an idle mode in which the radio transceivers 210, 218 are generally disabled to save power but communication can be resumed within a maximum permitted latency when needed.

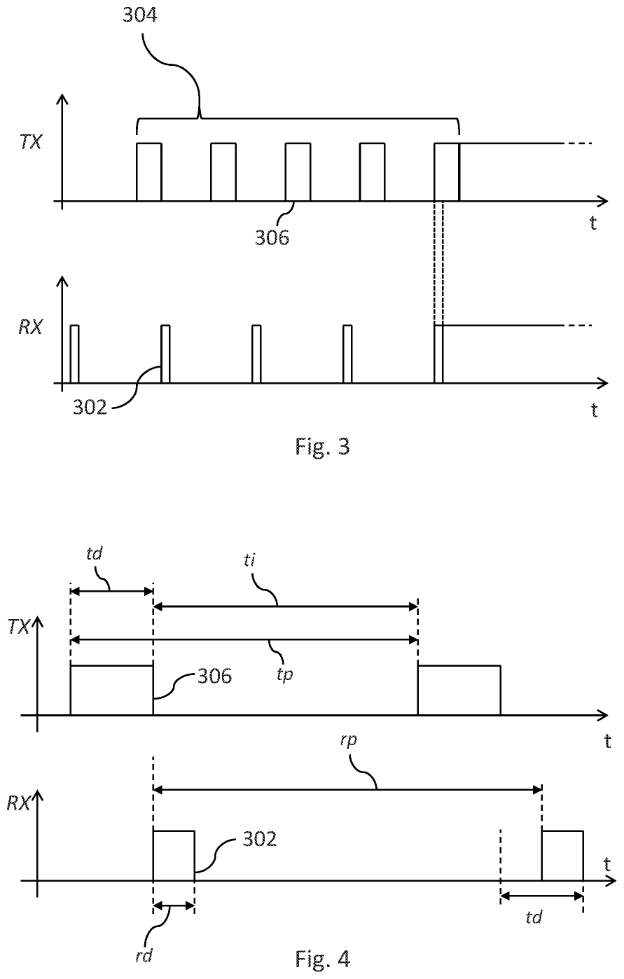

The idle mode operation will now be described with additional reference to FIGS. 3-6.

In a first embodiment, illustrated in FIG. 3, during the idle mode the second radio frequency device 204 powers on its radio transceiver 210 (RX) periodically for short sample windows 302. At other times, the radio transceiver device 218 is powered off.

During the idle mode, the first and second radio frequency devices 202, 204 do not maintain synchronisation. The first radio frequency device 202 thus does not know exactly when the sample windows 302 occur. The radio transceiver 210 (TX) of the first radio frequency device 202 is generally powered off, but when the first radio frequency device 202 wishes to initiate communication with the second radio frequency device 204, it transmits a wake-up sequence 304 of wake-up frames 306. The length of the wake-up sequence 304 is less than a maximum allowed latency for initiating the resumption of communications from the idle mode.

The wake-up frames 306 contain information identifying the second radio frequency device 204 as the target of the communication. In other words, the wake-up frames 306 are addressed to the second radio frequency device 204.

The second radio frequency device 204 detects the presence of the last wake-up frame 306 in the sequence 304. In response, the second radio frequency device 204 continues to sample the RF channel in order to determine the address information contained in the wake-up frame 306. The second radio frequency device 204 identifies from this information that it is the target of the wake-up frame 306 and so initiates full communication with the first radio frequency device 202 (e.g. by sending a data request frame to the first radio frequency device 202 or by waking at a future rendezvous time specified in the wake-up frame 306).

The second radio frequency device 204 knows the timing parameters of the wake-up sequence 304 and selects the pattern of the sample windows 302 accordingly to ensure that at least one of the wake-up frames 306 will be detected so that communication can be resumed within the maximum permitted latency. The timing of the sample windows 302 will now be explained with additional reference to FIG. 4.

The sample windows 302 have a duration rd and a period rp. The wake-up frames 306 have a duration td and are separated by a wake-up interval ti. The resulting period of the wake-up frames (td+ti) is tp. FIGS. 3 and 4 illustrate the “worst-case” latency situation, in which a sample window 302 falls just after the first wake-up frame 306 of the wake-up sequence 304.

In this embodiment, the sample period rp is longer than the wake-up frame period tp by an offset equal to a difference between the wake-up frame duration td and the sample duration rd. In other words:

$$rp = tp + td - rd . \qquad ( 1 )$$

In the situation illustrated in FIGS. 3 and 4, the nth sample window 302 will coincide with the (n+1)th wake-up frame so:

$$n \times rp = ( n + 1 ) \times tp \qquad ( 2 )$$

Combining (1) and (2) gives:

$$n \times ( tp + td - rd ) = n \times tp + 1 \times tp \qquad ( 3 )$$

$$n \times tp + n \times td - n \times rd = n \times tp + 1 \times tp$$

$$n \times td - n \times rd = tp$$

$$n \times ( td - rd ) = tp$$

$$n = \frac{tp}{td - rd}$$

If the maximum permitted latency is l, setting l=n×rp gives:

$$l = \frac{td}{td - rd} \times ( tp + td - rd ) \qquad ( 4 )$$

In this embodiment, the wake-up frame duration td is 800 μs. This is made up of: a five-byte synchronization header (SHR), a one-byte PHY header (PHR), an 18-byte MAC header (MHR) and a two-byte MAC footer (MFR) containing a CRC of the MHR. The MHR consists of a two-byte Frame Control Field (FCF), a ten-byte destination address (a two-byte Personal Area Network Identifier (Pan Id) and an eight-byte endpoint address) and a six-byte Rendezvous Time Information Element indicating a rendezvous time to start synchronized communication and the wake-up interval ti.

The duration rd of the sample windows 302 is minimised to minimise power-on time, but must be at least long enough to perform a channel sample that can detect a wake-up frame 306 (if one is present). In this embodiment, the sample duration rd is 128 μs.

The wake-up frame period tp may be set to be the maximum possible (to minimise power use of the first radio frequency device 202) without exceeding the maximum allowable latency. Acceptable maximum values for tp may be found by solving equation (4) for tp. In this embodiment, the maximum latency is 350 ms, so the wake-up frame period tp must be at least 15 ms.

A duty cycle of the radio transceiver of the first radio frequency device can be calculated according to:

$$dc = \frac{rd}{rp} = \frac{rd}{( tp + td - rd )} \qquad ( 5 )$$

Which, for the values explained above, is roughly 0.008.

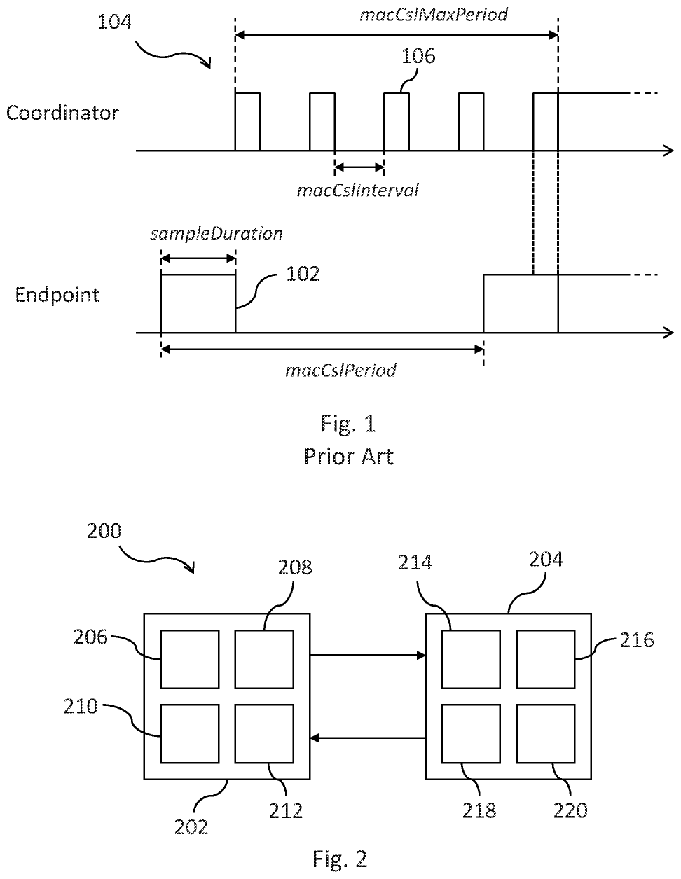

This may be compared to the conventional approach illustrated in FIG. 1, in which the endpoint duty cycle is (at least) macCslPeriod/macCslInterval. For the same sample interval and wake-up interval as in the embodiment shown in FIG. 3, the duty cycle of conventional endpoint CSL operation is roughly 0.04.

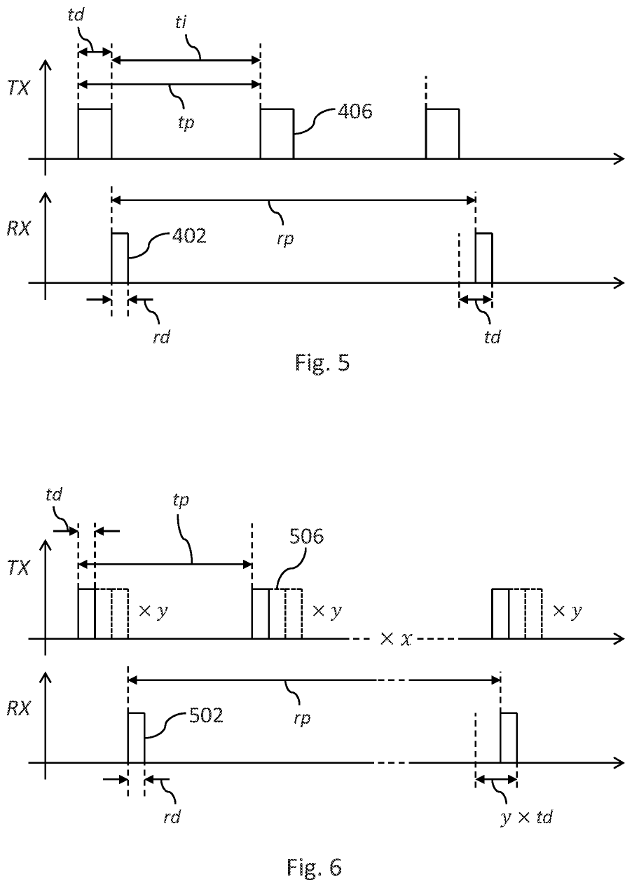

FIG. 5 shows an alternative embodiment in which the second radio frequency device 204 listens for wake-up frames 406 with a different pattern of sample windows 402. In this embodiment, the maximum permitted latency is 685 ms, and so the sample windows 402 may be spaced further apart.

In this embodiment, the sample period rp is two times the wake-up frame period tp plus an offset equal to a difference between the wake-up frame duration td and the sample duration rd. In other words:

$$rp = 2 \times tp + td - rd . \qquad ( 6 )$$

The nth sample window 302 will coincide with the (2n+1)th wake-up frame, so:

$$n \times rp = ( 2 n + 1 ) \times tp . \qquad ( 7 )$$

Combining (6) and (7) as before leads to the same result as equation (3):

$$n = \frac{tp}{td - rd} , \qquad ( 3 )$$

and using l=n×rp gives:

$$l = \frac{tp}{td - rd} \times ( 2 tp + td - rd ) . \qquad ( 8 )$$

Using the same values of tp, td and rd above the required latency of 685 ms is met with a duty cycle of roughly 0.004 (compared to 0.02 for the conventional approach).

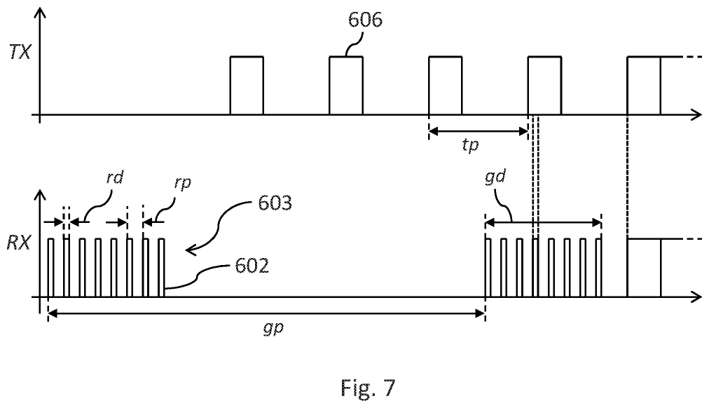

FIG. 6 shows a further alternative embodiment (not drawn to scale) in which the first radio frequency device 202 transmits extended wake-up frames 506, which are equivalent to y normal wake-up frames back to back, and the sample period rp is x times the wake-up frame period tp plus an offset equal to a difference between the wake-up frame duration td and the sample duration rd.

Using the same approach above for this situation gives:

$$rp = x \times tp + y \times td - rd . \qquad ( 9 )$$

$$l = \frac{tp}{2 \times td - rd} \times ( x \times tp + y \times td - rd ) . \qquad ( 10 )$$

$$rp = 2 \times tp + td - rd . \qquad ( 11 )$$

Appropriate values for x and y can be chosen to meet a required latency whilst considering power constraints of the first and second radio frequency device 202, 204. Generally, larger values of y (increasing power used by the first radio frequency device 202) allow for the use of larger values of x (i.e. decreasing power use from the second radio frequency device 204), for a given allowable latency.

FIG. 7 shows another embodiment in which the second radio frequency device 204 listens for a sequence of wake-up frames 606 with another different pattern of sample windows 602. The wake-up frames 606 have a wake-up frame period tp and wake-up duration td.

In this embodiment, the sample windows 602 occur in periodic groups 603 with a group period gp and a group duration gd. Within each group, the sample windows 602 are periodic with a sample period rp. The sample windows 602 have a duration rd, which is significantly shorter than the wake-up frame duration td. Because the sample windows are so short, the power used by the second radio frequency device 204 may be much less than conventional approaches. However, this also means that a wake-up frame can only be partially detected by a given sample window 602 (e.g. detecting only the presence of a wake-up frame).

Therefore, the pattern of groups of sample windows 602 is arranged such that even in the worst-case timing scenario, the second radio frequency device 204 will detect (partially) the penultimate wake-up frame 606 of the sequence. Based on this detection, the second radio frequency device 204 adjusts the pattern of sample windows (e.g. duration and period) to detect fully the final wake-up frame 606 in the sequence. FIG. 7 shows a situation that is near the worst-case timing.

The group duration is gd set according to:

$$gd \geq tp + 2 \times rd , \qquad ( 12 )$$

and the sample windows 602 in each group 603 have a sample period:

$$rp = td - rd . \qquad ( 13 )$$

The resulting on time for the second radio frequency device 204 in each group 603 is

$$\begin{matrix}{t}_{on} & = ( tp + 2 \times rd ) \times ( \frac{rd}{rp} ) \\ & = ( tp + 2 \times rd ) \times ( \frac{rd}{td - rd} )\end{matrix} . \qquad ( 14 )$$

And the resulting overall duty cycle for the second radio frequency device 204 is:

$$dc = \frac{( ( tp + 2 \times rd ) \times ( \frac{rd}{td - rd} ) )}{gp} . \qquad ( 15 )$$

gp is set by the maximum transmission latency allowed in the communication system and is less than an overall sequence length of the sequence of wake-up frames 606. For example, for values of tp=15 ms, td=800 us, rd=128 us, and l=685 ms, the duty cycle is roughly 0.004.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A radio frequency receiver arranged to monitor for wake-up frames in a plurality of sample windows;
wherein the wake-up frames are transmitted by a radio frequency transmitter in a sequence according to one or more sequence parameters including a wake-up interval between each wake-up frame of the sequence, and each sample window has a sample duration that is less than the wake-up interval; and
wherein the sample windows occur in a pattern based on at least one of the one or more sequence parameters, such that the radio frequency receiver is arranged to detect at least one of the sequence of wake-up frames.

2. The radio frequency receiver of claim 1, arranged to operate in:
an active communication mode for exchanging data payloads and/or signalling information with the radio frequency transmitter; and
an idle mode in which the radio frequency receiver is arranged to monitor for wake-up frames in the plurality of sample windows.

3. The radio frequency receiver of claim 1, arranged to enter a lower-power mode between the sample windows.

4. The radio frequency receiver of claim 1, wherein detecting a wake-up frame includes detecting a presence of the wake-up frame.

5. The radio frequency receiver of claim 1, arranged to adjust the pattern of one or more subsequent sample windows in response to detecting a wake-up frame.

6. The radio frequency receiver of claim 1, wherein the pattern of sample windows is such that the radio frequency receiver is arranged to detect a penultimate or earlier wake-up frame of the sequence.

7. The radio frequency receiver of claim 1, wherein the pattern of sample windows comprises one or more groups of sample windows.

8. The radio frequency receiver of claim 7, wherein each group has a group duration that is equal to or longer than the wake-up frame period plus two times the sample duration.

9. The radio frequency receiver of claim 1, wherein the sample windows are periodic with a sample period that is longer than the wake-up interval.

10. The radio frequency receiver of claim 9, wherein the sample period is equal to an integer multiple of a wake-up frame period plus or minus an offset.

11. The radio frequency receiver of claim 10, wherein the offset is based on the sample duration and a wake-up frame duration.

12. The radio frequency receiver of claim 1, wherein the radio frequency receiver is battery powered.

13. A non-transitory computer-readable medium comprising instructions stored thereon, that when executed by a radio frequency receiver, causes said radio frequency receiver to perform a method comprising monitoring for wake-up frames in a plurality of sample windows;
wherein the wake-up frames are transmitted by a radio frequency transmitter in a sequence according to one or more sequence parameters including a wake-up interval between each wake-up frame of the sequence, and each sample window has a sample duration that is less than the wake-up interval; and
wherein the sample windows occur in a pattern based on at least one of the one or more sequence parameters, such that the radio frequency receiver detects at least one of the sequence of wake-up frames.

14. A radio frequency communication system comprising:
a radio frequency transmitter arranged to transmit a sequence of wake-up frames according to one or more sequence parameters including a wake-up interval between each wake-up frame of the sequence;
a radio frequency receiver according to claim 1, arranged to monitor for the wake-up frames in a plurality of sample windows.

15. The radio frequency communication system of claim 14, wherein one or more of the wake-up frames comprises information relating to communications within the radio frequency communication system.

16. The radio frequency communication system of claim 15, wherein the information relating to communications within the radio frequency communication system comprises a target address identifying a receiver at which the wake-up sequence is targeted and/or a rendezvous time.

17. The radio frequency communication system of claim 14, wherein one or more of the wake-up frames comprises information relating to the sequence of wake-up frames, said information identifying the wake-up interval and/or a number of wake-up frames in the sequence.

18. The radio frequency communication system of claim 14, comprising a maximum communication latency, wherein the sequence of wake-up frames has an overall sequence length that is equal to or less than the maximum communication latency.

19. The radio frequency communication system of claim 18, wherein the pattern of sample windows comprises periodic groups of sample windows, with a group period that is equal to or less than the overall sequence length.

20. The radio frequency communication system of claim 14, comprising a low-rate wireless network such as a network according to IEEE standard 802.15.4.
